(19) United States
(12) Patent Application Publication
(10) Pub. No.: US 2011/0000170 A1
(43) Pub. Date: Jan. 6, 2011

(54) SYSTEM AND METHOD FOR GENERATING A SCHEDULE FOR ADMINISTERING DOSES OF MEDICATION TO A PATIENT

(75) Inventors: Bernard BURG, Menlo Park, CA (US); Masaaki Yamashita, Kanagawa (JP); Shinichi Takarada, Ehime (JP); Kristen Ingalz, San Jose, CA (US); Tomohiro Haga, Kagawa (JP)

Correspondence Address: GREGORY A. STOBBS, 5445 CORPORATE DRIVE, SUITE 400, TROY, MI, 48098, US

(73) Assignee: Panasonic Corporation, Osaka (JP)

(21) Appl. No.: 12/830,734

(22) Filed: Jul. 6, 2010

Related U.S. Application Data
(60) Provisional application No. 61/223,292, filed on Jul. 6, 2009.

(51) Int. Cl. G06Q 50/00; G06Q 10/00; B65B 5/04; B65B 61/20

(52) U.S. Cl. 53/474; 705/2; 53/238

(57) ABSTRACT

A method for generating a medication regimen of a patient is disclosed. The method comprises receiving a plurality of prescriptions for the patient, wherein a prescription of the plurality of prescriptions indicates a medication and a frequency for administering a dose of the medication. The method further comprises mapping a plurality of doses of one or more medications to a prescription calendar based on the frequencies indicated in the plurality of prescriptions and determining a schedule for administering a plurality of doses of different medications corresponding to each prescription of the plurality of prescriptions based on the calendar and constraints regarding administering the plurality of doses.

### CROSS-REFERENCE TO RELATED APPLICATIONS

This application claims the benefit of U.S. Provisional Application No. 61/223,292, filed on Jul. 6, 2009. The entire disclosure of the above application is incorporated herein by reference.

### FIELD

The present disclosure relates to a method and system for dispensing medication to a patient.

### BACKGROUND

It is currently estimated that only 50% of prescribed medications are actually taken by patients. Additionally, many patients do not complete a prescription through the therapy period. These deviations from therapy lead to approximately 225 million hazardous situations each year. Moreover, an average of 2.3 serious medication errors occur each month, primarily affecting elderly patients. Thus, there is a need for a device that will help ensure that prescribed therapies are adhered to by patients.

Beyond deviations from prescribed therapies, roughly 20% of prescriptions are never filled. Of those prescriptions that are filled, it is estimated that up to 60% of prescriptions are incorrectly taken or not taken at all. These problems may be primarily observed in older patients. Deviation from prescribed therapy may include simply not filling the prescription, overmedication, forgetting to take scheduled doses, deliberate under-dosing, accidentally taking the wrong medication, taking the correct medication at incorrect times, taking someone else's medication, taking dangerous combinations of medication, and hoarding medications for later consumption. It is posited that nearly 90% of elderly patients deviate from prescribed therapies in one way or another, and 35% make potentially serious errors.

It is envisioned that providing a patient with a presorted medication pack can help ensure that patients do not deviate from prescribed therapies or do not take a combination of drugs that may result in adverse effects. The presorted medication pack can be a traditional medication pack with a schedule printed thereon, or can be used in combination with a medication dispensing device. It is also envisioned that providing patients with customized schedules to use with a medication dispensing device may also reduce the risks associated with the administration of prescribed medications.

This section provides background information related to the present disclosure which is not necessarily prior art.

### SUMMARY

A method for generating a medication regimen for a patient is disclosed. The method comprises receiving two or more prescriptions for the patient, where each prescription indicates a medication prescribed to the patient and a frequency for administering doses of the medication to the patient and determining at least one constraint regarding administering the medications to the patient. The method further includes mapping each dose of medication to calendar slots of a calendar using a constraint propagation algorithm, where the constraint propagation algorithm recursively maps the doses of the prescribed medication to the calendar in accordance with the constraint and the prescribed frequency for administering the medication, and reschedules a previously scheduled dose of medication when a given dose of the medication cannot be mapped to the calendar in accordance with the constraint and the prescribed frequency for administering the medication.

In another aspect of the disclosure, a method for generating a medication regimen for a patient is disclosed. The method comprises receiving two or more prescriptions for the patient, where each prescription indicates a medication prescribed to the patient and a frequency for administering doses of the medication to the patient and receiving a set of constraints regarding administering the medication to the patient, each constraint having a priority in relation to the other constraints in the set of constraints. The method further comprises associating each of the constraints in the set of constraints with an applicable medication prescribed to the patient and identifying medication associated with the constraint having the highest priority in the set of constraints. The method also comprises mapping doses of the identified medication to a calendar using a constraint propagation algorithm in accordance with the associated constraint and the prescribed frequency for administering the identified medication.

In another aspect of the disclosure, a method for designing a layout of a medication pack is disclosed. The method includes receiving a plurality of prescriptions for the patient, wherein a prescription of the plurality of prescriptions indicates a medication and a frequency for administering a dose of the medication, and determining a schedule for administering a plurality of doses of different medications corresponding to each prescription of the plurality of prescriptions based on frequencies of the plurality of doses. The method further comprises generating a medication pack layout for the patient based on the schedule, wherein the medication pack layout of the medication pack corresponds to the schedule such that a dose of medication is mapped to a well of the medication pack, wherein the well of the medication pack corresponds to a time slot of the schedule.

This section provides a general summary of the disclosure, and is not a comprehensive disclosure of its full scope or all of its features. Further areas of applicability will become apparent from the description provided herein. The description and specific examples in this summary are intended for purposes of illustration only and are not intended to limit the scope of the present disclosure.

### DRAWINGS

FIGS. 1A and 1B are diagrams of an exemplary medication packaging supply chain;

FIG. 2A is a drawing illustrating exemplary components of regimen CAD system;

FIG. 2B is a flow chart illustrating an exemplary method that may be executed by the regimen CAD system;

FIGS. 3A, 3B, and 3C are drawings illustrating exemplary configurations of a medication pack and printed content;

FIG. 4 is a flow chart illustrating an exemplary method that may be executed by the regimen design module;

FIG. 5 is a flow chart illustrating an exemplary method that may be executed to map doses of medication to a calendar;

FIG. 6 is a drawing illustrating an example of assigning calendared doses of medication to time slots;

FIG. 7 is a flow chart illustrating an exemplary method that may be executed by the medication pack design module;

FIG. 8 is a diagram illustrating an exemplary deployment for the automated medication supply chain;

FIG. 9 is a diagram illustrating an alternative embodiment of the regimen CAD system; and

FIG. 10 is a diagram illustrating the overall data flow in the medication supply chain.

The drawings described herein are for illustrative purposes only of selected embodiments and not all possible implementations, and are not intended to limit the scope of the present disclosure. Corresponding reference numerals indicate corresponding parts throughout the several views of the drawings.

### DETAILED DESCRIPTION

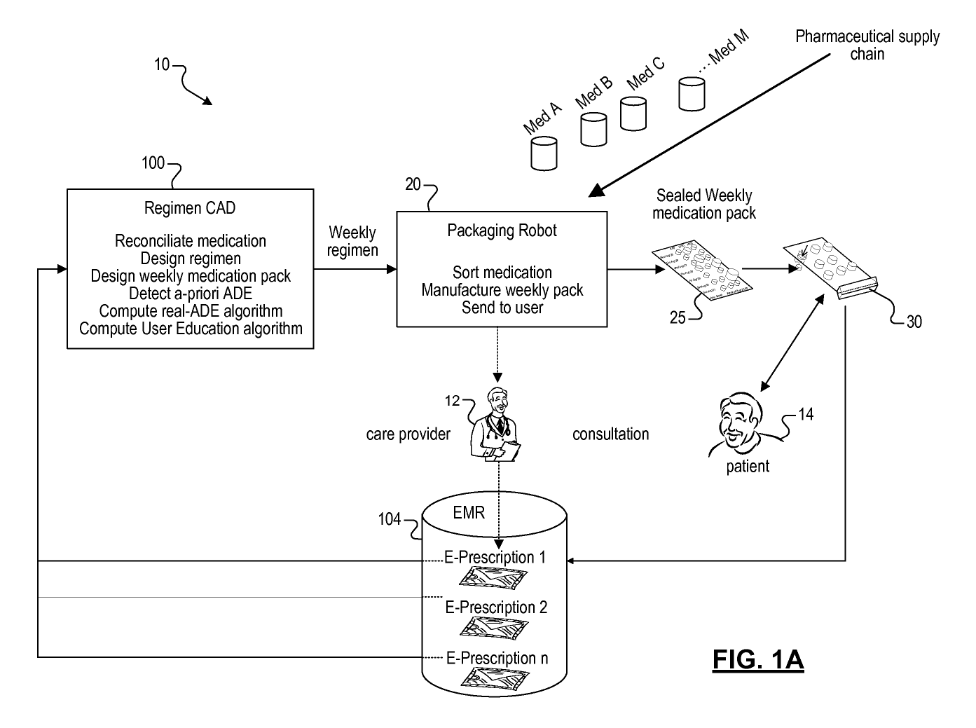

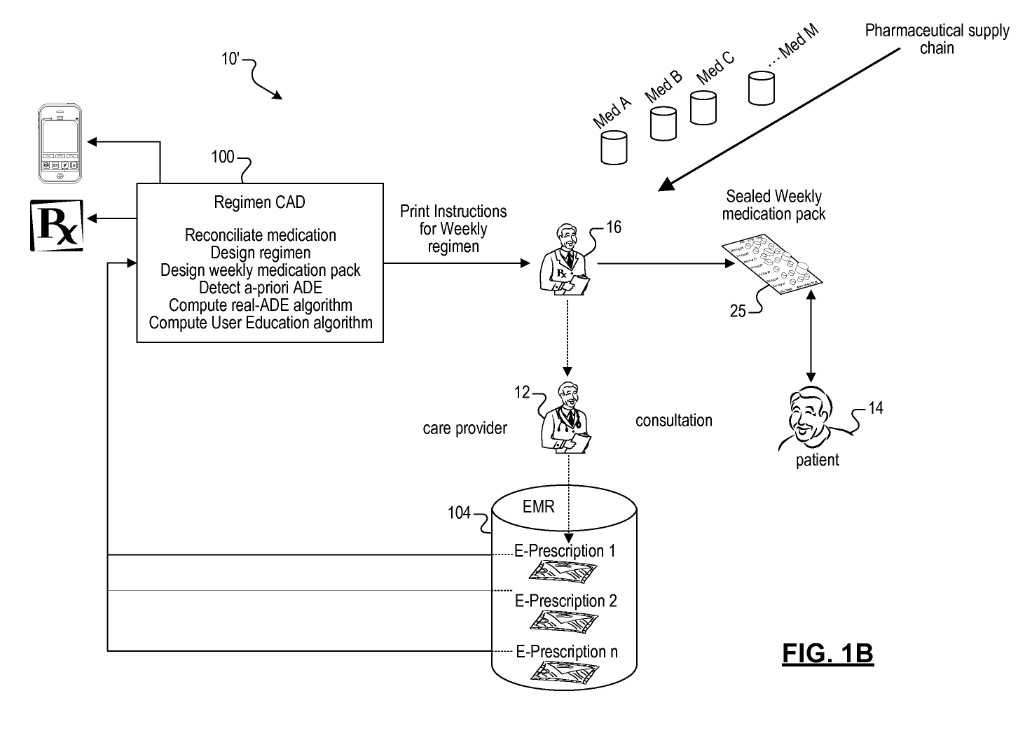

FIG. 1A illustrates an automated medication packaging supply chain 10 that is capable of designing, manufacturing and delivering personnel medication regimen packages to patients. Medications are presorted in packages in accordance with the patient's regimen and ready for use by the patients. The medication packaging supply chain 10 may include a computer aided regimen design (“regimen CAD”) system 100, a medication packaging robot 20, a medication dispenser device 30, and an electronic medical records database 104. Each of these components is further described below.

An overview of the exemplary medication packaging supply chain 10 is provided with reference to FIG. 1A. First, prescriptions are generated by a care provider 12. The care provider 12 may consult with the patient 14 when generating a prescription. Prescriptions for the patient are then communicated and stored in the medical records database 104. While reference is made to prescription, prescription medication, pharmaceutical drugs, or medication, it is understood that a patient may also take vitamins, dietary and health supplements, or other holistic treatments instead of or in combination with a prescribed medication. Thus, it is contemplated that such treatments are within the scope of the disclosure, and the prescription regimen may also include the foregoing types of treatments. Furthermore, medication packs, embodiments of which are described in greater detail below, can also contain vitamins, dietary or health supplements, or other holistic treatments contained therein.

Next, the regimen CAD system 100 transforms all of the patient's active prescriptions into a single reconciled weekly regimen. The regimen CAD system 100 may further design a medication pack in accordance with the prescription regimen. While reference is made to weekly regimens, it is understood that prescription regimens for other time periods, such as bi-weekly or monthly, also fall within the scope of this disclosure.

The medication packaging robot 20 receives as input the medication pack design from the regimen CAD system and manufactures an appropriate medication pack 25 that meets the design. In an exemplary embodiment, the medication pack 25 is shown as a blisterpack. This disclosure is not limited to blisterpacks but extends to other types of medication packs that provide containers that house one or more different doses of medication. Each container may correspond to a schedule entry in the regimen. For example, a container may correspond to a particular day of the week or a particular time of day. The medication pack is then delivered (e.g., sent by courier) to the patient.

In some embodiment, the medication packaging robot can be removed from the supply chain 10′ as shown in FIG. 1B. In this case, the prescription regimen and/or the medication pack design is sent to a pharmacy 16 or similar medical service provider. The pharmacist in turn prepares a medication pack for the patient. More specifically, the pharmacist will select a pre-configured medication pack and fill each container in the pack with the applicable medication in accordance with the prescription regime. The pharmacist may supplement the medication pack with instructions for taking the medication or warning information about the medication as required by an applicable regulatory agency. The filled medication pack is then sealed and delivered to the patient.

Upon receipt of the medication pack 25, the patient may manually dispense the medication from the medications pack 25 at the prescribed time. In one exemplary embodiment, the medication pack 25 may optionally interface with a medication dispensing device 30. The medication dispensing device 30 is configured to help administer the medication to the patient. For example, if the medication pack 25 is coded with an identifier for the patient, the medication dispensing device 30 will read the coded identifier and ensure a match with the patient before dispensing medication to the patient. The medication dispensing device 30 can also receive the prescription regimen for the patient. The prescription regimen can be read from the medication pack or received via a data interface from another data source. The medication dispensing device 30 may be also configured to collect and/or store compliance data as well as other data which can be reported back via the medical records database 104 to the care provider 12.

In an exemplary embodiment, communication amongst these components may be handled by web services, using XML messages transmitted in SOAP, UDDI service discovery and WSDL web services description language. The packaging robot can report back to the medical records database on pill lots and other traceability data necessary in the pharmaceutical industry and FDA related industry to comply to recall rules. In the exemplary embodiment, the wide area network interfaces may be designed in accordance with the Continua V1.5 interface design guidelines although other communication interfaces are contemplated by this disclosure.

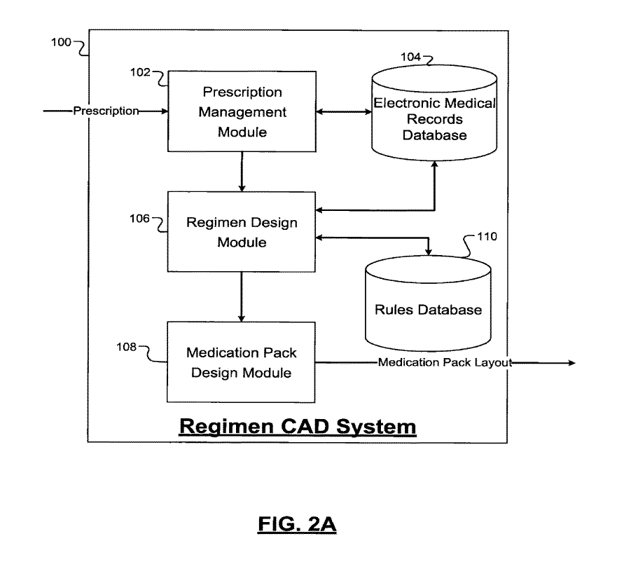

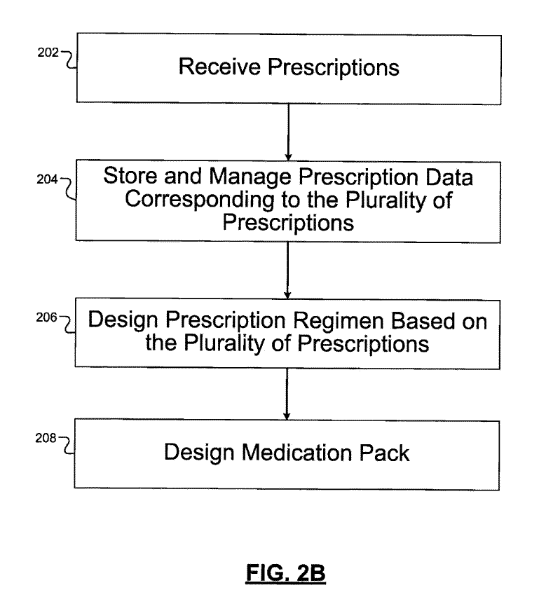

FIG. 2A illustrates an exemplary regimen computer aided design (“regimen CAD”) system 100. The regimen CAD system 100 is configured to receive one or more prescriptions of a patient from one or more prescription sources and to design a prescription regimen for the patient based on the prescriptions. A prescription may indicate, but is not limited to, a type of medication, an amount of medication to take per dose, a frequency for administering a dose, and a duration for administering the medication. For instance, a prescription may call for a patient to take 200 mg of Medication A, twice daily for two weeks. It is envisioned that the regimen CAD system 100 can also receive other treatment recommendations such as vitamins, supplements, or any other type of treatments that may be recommended to a patient. For instance, a physician may recommend that a patient take Vitamin X every morning with Medication A. For purposes of explanation, any type of treatment recommendation or prescription will be referred to as a prescription for medication.

An exemplary regimen CAD system 100 may be comprised of a prescription management module 102, a electronic medical records database 104, a regimen design module 106, and a medication pack design module 108. The prescription management module 102 receives a plurality of prescriptions for a patient and generates a prescription record for each prescription, which is stored in medical records database 104. The regimen design module 106 receives a list of prescriptions and generates a schedule for administering doses of medication. The medication pack design module 108 receives a schedule for administering doses of medication and designs a medication pack having a layout corresponding to the schedule for administering the doses of medication.

An exemplary method that may be executed by the regimen CAD system 100 is further described in relation to FIG. 2B. The prescription management module 102 receives a plurality of prescriptions from a plurality of prescription sources, as shown at step 202. A prescription can be received from a treating physician over the telephone, from a written prescription, or from an ePrescription service. When a prescription is received, the prescription management module 102 generates a record entry from the data corresponding to the prescription, as shown at step 204. The regimen design module 106 receives the plurality of prescriptions and designs a prescription regimen based on the plurality of prescriptions, as shown at step 206. Based on the prescription regimen, the medication pack design module 108 can design a medication pack for the patient, as shown at step 208. It is understood in some embodiments, the regimen CAD system 100 may not design a medication pack, but rather only the prescription regimen.

Referring back to FIG. 1, exemplary components and data structures of the regimen CAD system 100 are described in greater detail. A prescription record is a data structure that stores data relating to a patient's prescription. For instance, a list of elements in a patient record may include, but are not limited to: the patient's name, the primary physician, the prescribing physician, the prescription and related prescription data, including the medication, the dosage amount, the dosage frequency, the duration of the prescription, the amount of refills, active compounds of the drug, and any other data relating to the prescription. Further, a prescription record can have a flag indicating whether the prescription is active or no longer active.

The prescription management module 102 receives a prescription from a prescription source and parses the prescription. If a hand written prescription is received, a user may have to manually enter the prescription via a user interface. Similarly, if a prescription is received over the telephone, voice recognition may be performed or a user may enter the prescription manually. Once the prescription is received from the prescription source, the prescription management module 102 can use known parsing techniques to parse the prescription and create a record. The prescription is parsed such that the contents of the prescription are identified and entered into the appropriate field of the prescription record. The parsed prescription can be represented in various languages or formats. For instance, the parsed prescription can be stored in the electronic medical records database 104 in XML.

The prescription records described above are but one example of a prescription record. It is envisioned that the prescription record database 102 may store prescription record entries that are patient-centric instead of or in addition to the prescription-centric entries. For instance, a patient may have a single prescription record entry which can store a plurality of prescriptions in the record entry. Furthermore, a prescription record entry may indicate a history of treatments and prescriptions of the patient. The prescription record may also store patient information such as allergies, daily schedule, or other constraints. The regimen CAD system 100 may also incorporate a patient interaction mechanism that allows a patient to enter policies regarding his or her treatment regimen. While this information may be entered by a prescribing physician or the like, the information may also be entered by a patient via a user interface. The patient may enter information relating to his or her general habits and preferences, such as the daily schedule, preferences for scheduling of doses, regular eating habits, or the like. This information can be used by the regimen CAD system 100 to generate additional constraints when determining a schedule for administering doses of medication.

The prescription management module 102 can be further configured to perform additional tasks. In some embodiments, the prescription management module 102 can verify a prescription. For example, the prescription management module 102 can verify that the prescribing physician is in fact a valid physician. This can be done, for example, by keeping a list of registered physicians in a database accessible to the prescription management module 102. The prescription management module 102 can also check if the prescription is still valid or if it is expired. In some embodiments, the prescription management module 102 can be configured to determine if the prescribed medication itself, is a valid medication. This can be achieved, for example, by checking a trusted drug database (not shown).

The prescription management module 102 can also determine whether a patient should take a prescription. The prescription record database 104 may store additional data related to the patient, such as specific allergies or conditions. Thus, when a prescription is received, the prescription management module 102 can obtain a list of components of the medication and determine if the patient is allergic to any of the components. The list of components may be provided with the prescription, or may be obtained from a drug database.

As discussed, the prescription management module 102 generates and manages prescription records in the electronic medical records database 104. The electronic medical records database 104 stores the prescription records and is accessible to at least the prescription management module 102 and the regimen design module 106. In some embodiments, the electronic medical records database 104 may be indexed and searchable according to various record entries, such as patients, medications or components thereof, allergies of patients, expiration dates of prescriptions, and other entry types. Furthermore, as the electronic medical records database 104 stores patient information, the electronic medical records database 104 should be compliant with HIPAA standards or a jurisdictional equivalent thereof, and compatible with current medical standards, such as HL7 or SNOMED. Furthermore, the electronic medical records database 104 should be secure, maintained, and auditable, so as to maintain the integrity of the data stored thereon.

The regimen design module 106 receives a plurality of prescriptions for a patient from the prescription management module 102 and/or from the electronic medical records database 104. Once the prescriptions of a patient have been received, the regimen design module 106 designs a prescription regimen for the patient based on the prescriptions. The prescription regimen module 106 defines a schedule for administering a plurality of doses of different medications based on the frequency for administering each dose and the constraints regarding the administration of the medications. As will be described in greater detail, the regimen design module 106 may reconcile the received prescriptions with one another, map the doses for each prescription to a calendar, generate a schedule for administering the doses based on the calendar regarding the prescriptions, and then design a medical package based on the schedule. The specific constraints may require, for example, that two medications be taken at the same time or that a particular medication be taken within an hour of going to sleep or at a scheduled eating time. As will be described below, constraints are obtained from policies, which provide general guidelines for administering medication to the patient.

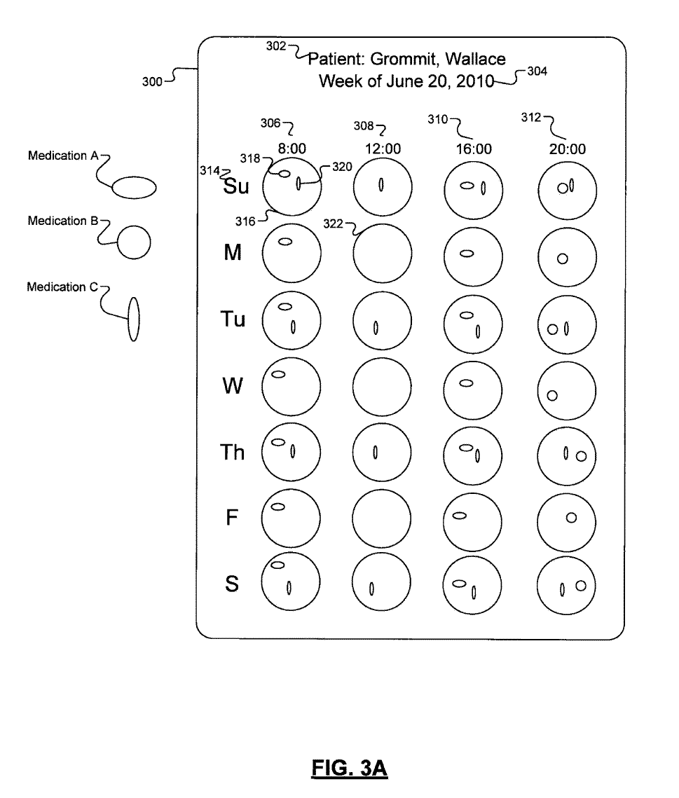

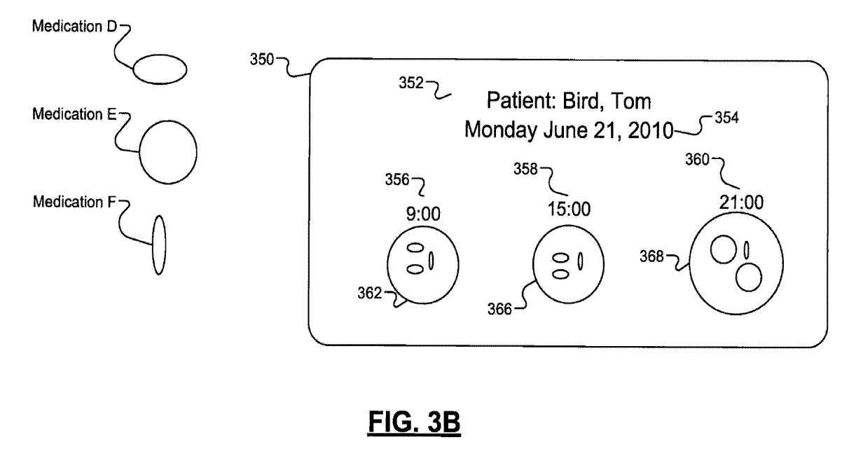

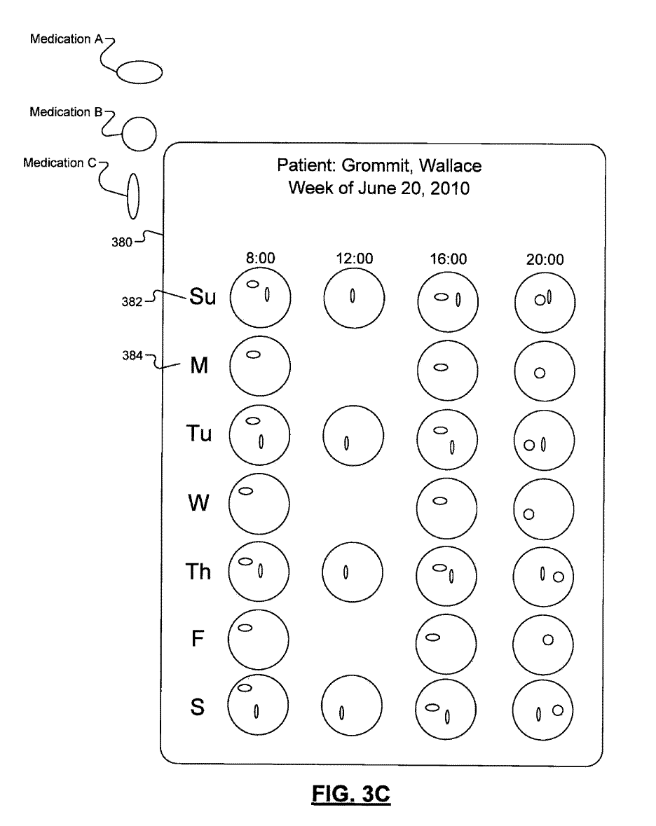

Once a schedule for administering a plurality of doses of different medication has been generated, the medication pack design module 108 can design a medication pack based on the schedule. The medication pack design module 108 designs a layout for a medication pack that corresponds to the schedule. FIGS. 3A and 3B illustrate exemplary medication packs that may be designed by the medication design pack module.

The exemplary medication pack 300 in FIG. 3A corresponds to a schedule that has four scheduled doses during the day. In this example, a patient Wallace Grommit is prescribed three medications: Medication A, Medication B, and Medication C. Medication A is prescribed twice daily with food. Medication B is prescribed once a day before patient goes to sleep. Medication C is prescribed four times a day, every other day. Based on the prescriptions and the constraints corresponding thereto, the regimen design module 106 generates a schedule for administering the doses. The schedule is communicated to the medicine pack design module 108. The medication pack design module 106 is configured to design a medication pack layout based on the schedule. In this example, the schedule dictates that doses of medication are taken at 8:00 AM, 12:00 PM, 4:00 PM and 8:00 PM. Furthermore, the schedule indicates which medications are taken on what days and at what times. For example, Medication B is taken at 8:00 PM every day. Based on the schedule and other factors, such as the size of each medication, the medication pack design module 108 designs the layout for the medication pack, including how many medication wells 316 to include in a pack and the size of the medication wells 316.

Furthermore, the medication pack design module 108 generates the printed content for the medication pack 300. In FIG. 3A, the medication pack design module 108 has generated a layout for medication pack 300 that includes printed content indicating the patient's name 302 at the top of the medication pack 300 and the validity time period 304 for the medication pack located below the patient name 302. Furthermore, the printed content may indicate the time slots for the scheduled doses, e.g. time slots 306, 308, 310, and 312 as well as the various days of the week, e.g. day 314. The printed content may also include instructions for taking a medication and/or warning information issued by an applicable government agency.

The medication pack layout will also include which medications are placed in which medication wells. For instance, with respect to well 316, a pill 318 of Medication A and a pill 320 of Medication B are mapped to well 316. According to the schedule, the pills 318 and 320 are to be administered to the patient at 8:00 AM on Monday. Further, some wells may be left empty. For instance, well 322 is empty, as the schedule calls for Medication C to be administered every other day. Because no other medication is scheduled to be taken at 12:00 PM on Tuesday, well 322 has no medications contained therein.

In the example of FIG. 3B, the medication pack 350 is a daily medication pack with three scheduled doses. Medication pack 350 includes the printed content 352 for a patient Tom Bird. Also, the medication pack includes printed content 354 indicating the day of the medication pack. Printed content 356, printed content 358, and printed content 360 indicate scheduled times for administering the pills contained in the respective wells 362, 366, and 368. As can be seen from FIG. 3B, Medication E is larger than Medication D and Medication F. Recognizing this, the medication pack design module 108 can be configured to select wells having different sizes to accommodate pills of larger size or time slots requiring greater amounts of medication.

The medication pack layouts described above are exemplary in nature and are not intended to be limiting. Greater details are provided below on the generation of a medical pack layout.

It is envisioned that the medical pack layout can be communicated to a variety of different devices or locations to prepare the medication pack. For instance, the medical pack layout may be communicated to a medication packaging device that is designed to receive a layout, including the identities of the medications for each well, and to prepare a medication pack automatically. Alternatively, the medical pack layout may be communicated to a pharmacy or the like, and a packager, e.g. pharmacist or nurse, can package the doses in the medication pack according to the layout. Furthermore, a combination of the foregoing is also contemplated, such that a medication packaging device prints the printed content on the medication pack and the user manually fills the wells of the medication pack.

Referring back to FIG. 2A, it is envisioned that various configurations for the regimen CAD system 100 exist. For instance, in some embodiments, the regimen CAD system 100 may not include a medication pack design module 108, as the schedule for administering the doses may be used in a medication dispensing device, such that no medication pack is needed. In these instances, the regimen design module 106 generates a schedule for administering the doses of different medications, and the schedule can be communicated to the medication dispensing device, which can dispense medication to the patient according to the schedule.

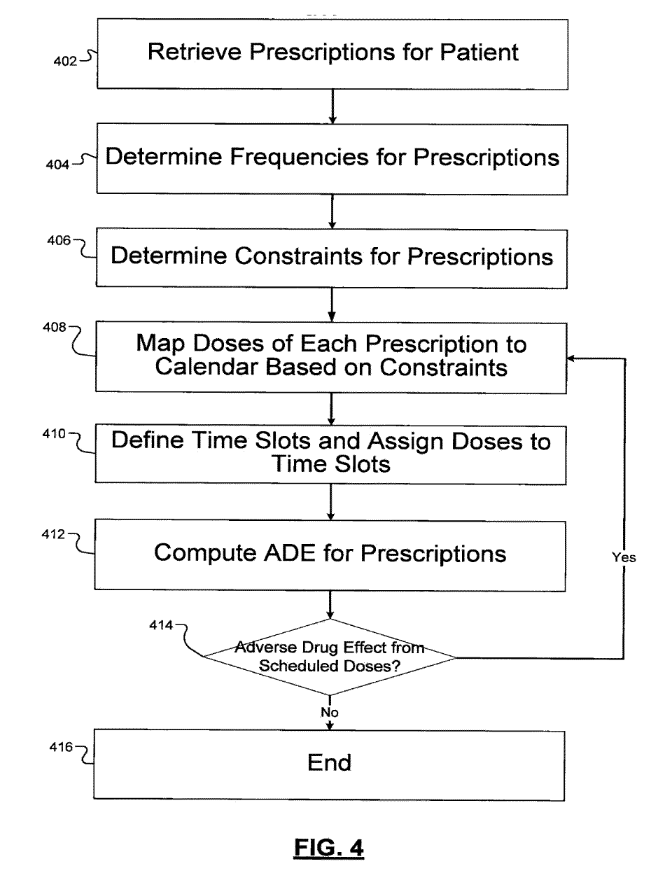

Referring now to FIG. 4, an exemplary method for generating a schedule for administering doses of different medications is depicted. As described above, a patient will have at least one prescription prescribed thereto. When initiated, the regimen design module 106 will receive the prescriptions from either the prescription management module 102 or the electronic medical records database 104, as shown at step 402. For each prescription received, the regimen design module 106 will determine a frequency of the doses of a medication, as shown at step 404. In exemplary embodiments, each prescription will indicate a frequency of doses. Thus, in some embodiments, the frequency of the doses of the medication can be retrieved from the prescription data stored in the electronic medical records database 104. The frequency of administering the doses may also be retrieved from other sources, such as from a medication database maintained by a pharmaceutical company.

A patient's treatment regimen may also have policies defining how a medication should be administrated to a patient. These policies may be specific to the prescription, rather than the patient. Other policies may be patient specific. These policies may be dictated by a patient's specific preferences or conditions. Examples of policies may include: take medicines on full stomach or on empty stomach, take medicines prior to going to sleep, take specific medications with one another. The policies may be put in place by a doctor or a medication provider, e.g. “do not take on an empty stomach,” or the patient, “I do not want to take medicine more than four times a day.” The policies can be parsed from the prescriptions, or can be received from a treating physician, a drug manufacturer, or the patient. Once parsed, the policies can be stored in the electronic medical records database 104 as such. The foregoing may be performed by the regimen design module 106 or by the prescription management module 102.

Constraints are specific rules relating to the administration of the prescription to the patient. The regimen design module 106 determines the constraints based on the policies relating to the prescriptions, as shown at step 404. A rules database 110 can be maintained which relates policies to constraints. In an exemplary embodiment, each policy maps to a set of one or more constraints, where the constraints can have priorities with respect to one another. Priorities assigned to constraints are then used to determine an order for assigning doses of medication to a calendar.

The regimen design module 106 queries the rules database 110 using a policy and/or the patient's information. The regimen design module 106 receives a set of one or more constraints regarding administering the medication to the patient, wherein the constraints have a priority in relation to the other constraints in the set of constraints resulting from the query. For instance, a policy may require a patient to take medication only after waking up and before going to sleep. The patient information may indicate that the patient generally wakes up at 8:00 AM and goes to sleep at 10:00 PM. The regimen design module 106 queries the rules database 110 using the policy and the patient information and formulates a constraint that the medication must be taken around 8:00 AM and 10:00 PM. The resulting constraint may be stored in the electronic medical records database 104 with respect to the patient for future reference.

Other types of policies may require an inference or assumption to be made in order to obtain a constraint. Based on the policy and the patient information, the query result assumes specific conditions to be true, in order to return a constraint. For example, a policy may be that Medication A must be taken with Medication B, or that Medication A must be taken after eating. In the former scenario, although the regimen design module 106 is determining constraints for Medication A, an inference will be made that the patient is taking Medication B, such that the constraint is Medication A and Medication B are taken at the same time. In the latter scenario, an assumption may be made that the patient eats shortly after waking up or a few hours before going to sleep. Thus, the constraint may be that Medication A can be taken at 9:00 AM, or after other assumed eating times.

Once the constraints for administering doses of medication are determined, the constraints are associated with one or more medications prescribed to the patient. The constraints can be represented by logical rules indicating when or how medication should be administered. For instance, the constraints may include but are not limited to: “Take Medication X at a given time,” “Take Medication X on before a scheduled eating time,” “Take Medication X with Medication Y,” “If taking Medications X and Y do not take Medication X and Medication Y at the same time,” “Take Medication X once every day,” or “Take Medication X, once weekly.” Once the constraints are associated with the prescribed medications, the regimen design module 106 can assign various doses to a calendar based on the frequencies and the constraints, as shown at step 408.

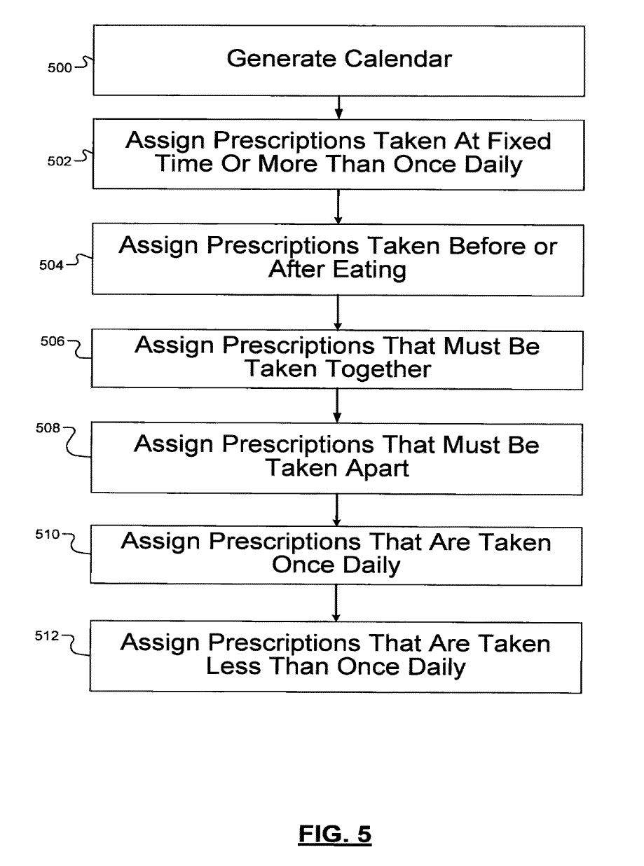

FIG. 5 illustrates an exemplary method for assigning doses of each prescription to calendar slots of a calendar according to a default set of constraints. In the exemplary default set, the constraints are applied as follows: assign prescriptions taken at a given time (having a highest priority equal to one); assign prescriptions taken on empty stomach (priority=2); assign prescriptions to be taken together (priority=3); assign prescriptions to be taken separately (priority=4); assign prescriptions taken once a day (priority=5) and assign prescriptions taken less than once daily (priority=6).

First, the regimen design module 106 generates a calendar as shown at step 500. In an exemplary embodiment, the regimen design module 106 selects a default calendar having pre-defined calendar slots over a fixed period of time. For example, the default calendar can specify four calendar slots for each day. Alternatively, the patient or care taker may specify the calendar. For example, a patient may define convenient time slots for taking medication (e.g., two time slots per day: breakfast at 8 AM and dinner at 6 PM). In any case, each calendar slot signifies a time of day at which to administer the dose of medication. Calendar slots can occur at different time increments. For instance, the calendar slots may be 30 minutes apart, 1 hour apart, 2 hours apart or a day or more apart. Likewise, the calendar duration may be for a single day, a week, a year, a duration of a treatment cycle, or any other time period.

The regimen design module 106 may further customize the calendar a particular patient. For example, the regimen design module 106 may receive a patient's daily schedule from the electronic medical records database. On a weekday, the patient is awake from 7:00 AM to 10:00 PM; whereas, on a weekend day, the patient is awake from 9:00 AM to 11:00 PM. The regimen design module 106 will then allocate the calendar slots during the time the patient is awake. Additionally (or alternately) the regimen design module 106 may receive the patients daily eating times and allocate the calendar slots adjacent to the patient's eating times. Other types of allocation schemes and customization are contemplated by this disclosure.

In designing a patient's regimen, the regimen design module 106 can read in all of a patient's prescriptions. For each prescription, the regimen design module 106 will look to the frequency of the doses. In some instance, a medication is to be taken at one or more fixed times. For instance, a prescription may have the patient take medication at 8:00 AM and 8:00 PM. The regimen design module 106 will first assign these medications to the corresponding slots in the calendar. Medications that are to be taken more than once a day are then assigned to the calendar as shown at step 502. This may be achieved by dividing the total time specified in a patient's calendar (e.g., 14 hours for a calendar between 8 am and 10 pm) or in a calendar entry (e.g. 24 hours in a day) by the amount of doses prescribed per day. The doses are then assigned to specific times in the calendar accordingly based on the patient's daily schedule. For example, if a patient is wakes up at 8:00 AM, the doses be scheduled starting at 8:00 AM. Alternatively, the regimen design module 106 may associate specific frequencies with predetermined time periods. For example, if a medication is taken twice daily, the regimen design module 106 will assign the first dose at a calendar slot corresponding to the patient's waking time and will assign the second dose 12 hours later. The regimen design module 106 can then assign doses having other constraints to calendar slots of the calendar. It is noted that some medications that are taken more than once a day may have additional limitations. When scheduling these medications, the regimen design module 106 can take the additional constraints into account when assigning the doses to the calendar. Thus, the teachings below can be applied when assigning multiple doses of a medication having additional constraints to a single day.

The regimen design module 106 can next assign prescriptions that must be taken before or after eating, as shown at step 504. Thus, the regimen design module 106 may first attempt to assign the dose of medication to a calendar slot before or after a first eating time. If a conflict with a medication exists at a given time, then the regimen design module 106 will assign the dose of medication to a calendar slot corresponding to a later eating time. A conflict is a condition that exists that does not allow a particular medication to be taken at a particular time. One source of conflicts is an adverse drug effect resulting from the combination of the medication with one or more other medications. Adverse drug effects are described in greater detail below. Other conflicts may be that the side effects of a medication do not make the proposed time feasible, e.g. the medication causes drowsiness and the proposed time is in the morning.

The regimen design module 106 can next assign all medications that have to be taken with another medication to calendar slots of the calendar, as shown at step 506. If one of the medications that must be taken together has already been assigned to the calendar slot, then the unassigned dose is assigned to the same time as the previously assigned dose. If none of the medications that must be taken with each other have been assigned to the calendar, then the doses can be assigned to any calendar slot that would not create a conflict. For example, this may be achieved by scheduling the doses to the first earliest calendar slot that would not create a conflict with another medication, according to a patient preference, or the time having the least amount of medication assigned thereto.

The regimen design module 106 can next assign medications that cannot be taken with each other to calendar slots, as shown at step 508. The medications that cannot be taken with each other can be assigned to calendar slots that allow for the greatest amount of time between doses. For instance, if Medication A and Medication B cannot be taken with one another, then Medication A can be assigned to the 8:00 AM calendar slot and Medication B is assigned to the 10:00 PM calendar slot.

Finally, the regimen design module 106 assigns the doses that are taken once daily, as shown at step 410, and once weekly, as shown at step 412. These doses can be assigned to any calendar slot that would not create a conflict. For example, this may be achieved by scheduling the doses to the first earliest calendar slot that would not create a conflict with another medication, according to a patient preference, or the calendar slot having the least amount of medication assigned thereto.

The foregoing method is an exemplary method for assigning doses to a calendar. It is noted that the ordering of the steps is not essential, and that other steps may be included. Additionally, certain constraints may be given higher priorities over other constraints. The method described above can be rearranged or can include additional constraints in accordance to the priorities of the constraints. Furthermore, the foregoing method highlights the most typical constraints regarding prescriptions. It is further noted that doses may be scheduled according to other constraints as well.

Additionally, pharmacists and/or physicians may further define different policies to apply to different types of patients. Different policies in turn map to different sets of constraints. For example, an ulcer patient may require the minimizing of stomach bleeding. Therefore, an ulcer policy may emphasize taking particular medications on an empty stomach or additional constraints may be put in place for taking a particular medication on a full stomach. In an exemplary embodiment, the patient defines meal times and the regimen design module 106 generates a calendar encompassing before and after meal calendar slots for empty and full stomach criteria, respectively. In this case, the ulcer policy maps to the following set of constraints: assign prescriptions taken on empty stomach (priority=1); assign prescriptions taken on full stomach (priority=2); assign prescriptions to be taken together (priority=3); assign prescriptions to be taken separately (priority=4); assign prescriptions taken once a day (priority=5) and assign prescriptions taken less than once daily (priority=6). This set of constraints can then be applied by the regimen design module 106 in the manner described above.

Similarly, some patients may have allergies to certain reactants. In these scenarios, the algorithm may place a greater emphasis on constraints aiming to maximize the times between doses of medication having an allergy inducing reactant. Some patients may ask a doctor to minimize the number of times medication is taken, and the algorithm may be adjusted to accommodate such demands. In some instances, a patient may require maximum efficiency regardless of discomfort. The constraints and hierarchy thereof can be adjusted to facilitate a maximum efficiency treatment regimen.

Furthermore, in the exemplary method shown in FIG. 5, or in variations thereof, the method can be modified to handle deadlocks. As described above, if a conflict exists between a dose of a medication being assigned to the calendar and the proposed time or a previously scheduled medication at that time, the regimen design module 106 assigns the medication being assigned to the next available time on the calendar. In some instances, however, the conflict may not be resolvable regardless of when the dose being assigned is scheduled. These scenarios are referred to a deadlock. To handle these instances, the method may be modified, such that it alters the assignments of previously assigned doses to resolve the deadlock. To resolve these types of situations, the regimen design module 106 can be configured to execute a constraint propagation algorithm that recursively maps the doses of the prescribed medication to the calendar in accordance with the constraint and the prescribed frequency for administering the medication, and reschedules a previously scheduled dose of medication when a given dose of the medication cannot be mapped to the calendar in accordance with the constraint and the prescribed frequency for administering the medication.

In some embodiments, the constraint propatation algorithm may be a back tracking algorithm or another type of simple forward checking algorithm. An exemplary backtracking algorithm will resolve conflicts by iteratively attempting to schedule the current dose at a different calendar slot. If the conflict cannot be resolved by scheduling the current dose at a different time, the algorithm will attempt to reschedule a previously scheduled dose at the next available calendar slot. The next available calendar slot is the calendar slot that temporally follows the calendar slot having the conflict. The algorithm then will try to schedule the current dose again. If a deadlock still exists, then the algorithm will attempt to reschedule the previously scheduled dose at yet another time, and then attempt to schedule the current dose again. This will repeat until both doses are scheduled or it is determined that the previously scheduled dose cannot be scheduled without creating a deadlock. In the latter case, the algorithm will attempt to reschedule another previously scheduled dose in an attempt to undo the deadlock. The backtracking algorithm may continue backtracking until the deadlock is resolved.

Furthermore, a step may be added where if a deadlock cannot be resolved, a notice may be sent to a physician of the patient.

Referring back to FIG. 4, once the regimen design module 106 has assigned the doses to a calendar, the regimen design module 106 may further constrain the prescription schedule to a number of time slots for administering the doses. For instance, a patient may only want to take medication three times a day, a medication pack may only have space for four time slots, or studies may show that a patient is more likely to forget to take medicine if the patient has to take more than four times a day. The number of time slots is a parameter that may be pre-configured by the patient, care taker or in some other manner. The regimen design module first identifies the number of time slots and then assigns the doses of medication to the time slots. Thus, the regimen design module 106 may be limited a defined maximum number of time slots.

An exemplary technique for mapping the calendar slots to a pre-configured number of time slots for administering the doses is further described below. The regimen design module 106 may first determine whether the number of calendar slots having doses assigned thereto is greater than the number of time slots. If not, then the calendar slots can map directly to the times having doses assigned thereto. If, however, the amount of times having at least one dose assigned thereto exceeds the number of time slots, then the regimen design module 106 can assign a time to each time slot based on the hierarchy of constraints, the number of doses scheduled at each time, or other considerations. After the time slots are defined, the doses of each medication can be assigned to a time slot. If a dose is scheduled for a time corresponding to a defined time slot, then it is assigned to that time slot. If a dose is mapped to a time not corresponding to a time slot, it can be assigned to the closest time slot temporally. Other rules for mapping doses to defined time slots are also contemplated by this disclosure.

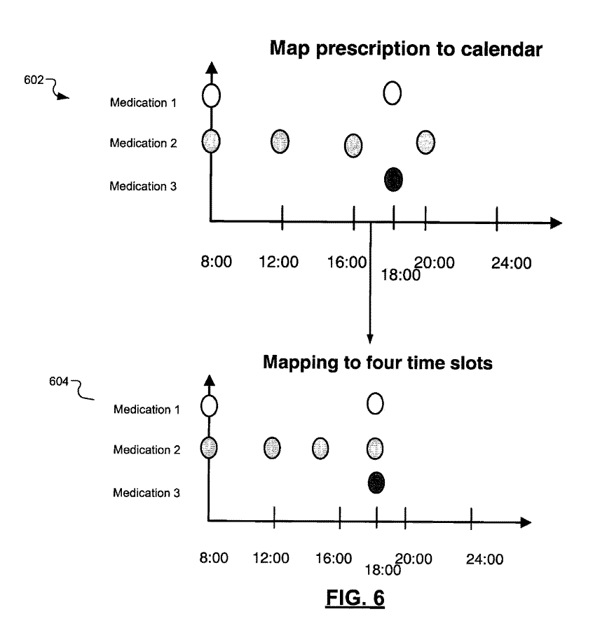

FIG. 6 illustrates an example of the foregoing. In FIG. 6, the calendar 602 has three medications to be administered to the patient. Doses of Medication 1 are assigned to 8:00 AM and 6:00 PM, doses of Medication 2 are assigned to 8:00 AM, 12:00 PM, 4:00 PM and 8:00 PM, and a dose of Medication 3 is assigned to 6:00 PM. In this example, the regimen design module 106 defines four time slots 8:00 AM, 12:00 PM, 4:00 PM, and 6:00 PM. The doses are then assigned to the time slots. In this example, the majority of scheduled doses are unaffected. The final dose of Medication 2, however, is assigned to the 6:00 PM time slot by the regimen design module 106.

Once the doses have been assigned to time slots, an initial schedule has been generated. The regimen design module 106 can analyze a schedule to determine if an adverse drug effect may result from taking the medication according to the schedule, as shown at step 412. As was discussed, the components of each medication may be stored in the electronic medical records database 104. Thus, the medications themselves or the components thereof can be analyzed in view of the other medications scheduled to be administered to determine if an adverse drug effect may occur. Any other means of determining adverse drug effects may be implemented and are within the scope of the disclosure. If an adverse drug effect is possible, then the method steps back to step 408 so that the calendar can be adjusted. The foregoing may run iteratively until a schedule that does not result in adverse drug effects is generated. Further, the adverse drug effect checking can be done at different stages. For example, the adverse drug effect checking may be performed when the calendar is being generated, such that a dose is assigned to the calendar only if it would not result in an adverse drug effect. Once a schedule has been generated that does not result in adverse drug effects, the regimen design module 106 ends.

In some embodiments the generated schedule may be used to design a medication pack for the patient. Thus, referring back to FIGS. 1 and 2, after a schedule for administering doses of medication has been generated, the medication pack design module 108 can design a medication pack layout based on the generated schedule.

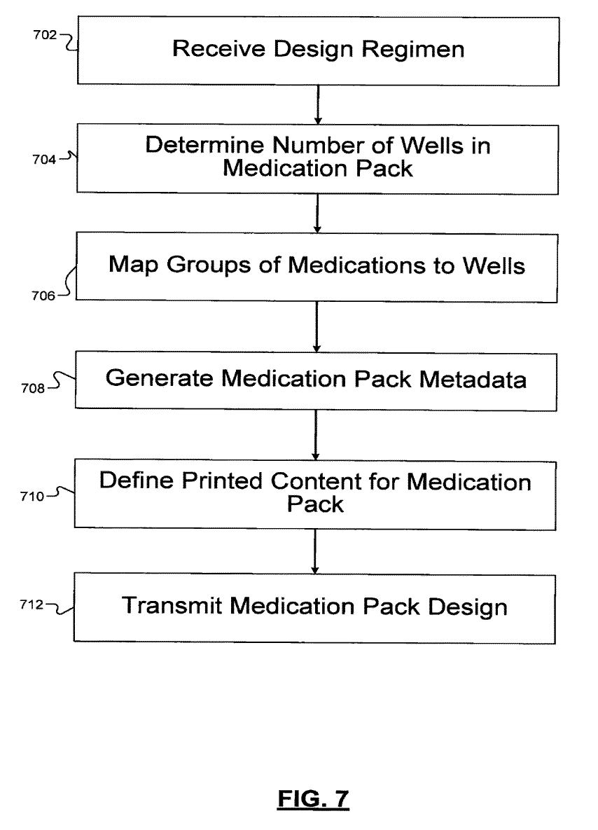

FIG. 7 illustrates an exemplary method for designing the layout of a medication pack. The medication pack design module 108 receives a schedule for administering doses of medication from the regimen design module 106 or the electronic medical records database 104, as shown at step 702. Based on the schedule, the medication pack design module 108 selects an amount of columns, i.e. an amount of medication wells in a row, and an amount of rows in a medication pack, as shown at step 704. The amount of columns can be set equal to the amount of time slots in a given day. The amount of rows can be set equal to the amount of days in the schedule. For instance, if a schedule is received for a single day having four time slots, then the medication pack design module 108 can select a medication packet having four medication wells. If a schedule is received for a week having three time slots, then the medication pack design module 108 selects a medication pack having seven rows with three medication wells in each row.

Furthermore, a patient may prefer to have a medication pack for a specific amount of days. For instance, a patient may desire to have a daily medication pack, a weekly medication pack, or a monthly medication pack. Thus, the amount of rows in a medication pack can also be defined by a user.

The layout for the medication packs can be customized or can be selected from pre-configured medication packs. A customized medication pack can have any number of medication wells in a row and any number of rows. Pre-configured medication packs are designed in advance. This means that the medication pack design module can select a medication pack from a plurality of medication packs having varying amounts of columns. If the medication packs are preconfigured, the medication pack design module 108 selects the medication pack with the least amount of columns that is able to accommodate the number of time slots in the schedule. For instance, if a schedule has 5 time slots and the medication packs can have 4, 7 or 11 columns, the medication pack design module 108 selects the medication pack having 7 columns.

Once the amount of medication wells and rows is defined, then the doses of the medications are mapped to the individual wells, as shown at step 706. During this step, the medication pack design module 108 identifies each medication that will be entered into a well. The medication pack design module 108 can further be configured to verify that all the medications can fit into the well. In an exemplary embodiment, the medication pack design module 108 retrieves the information for each medication to be included in the well to verify that each medication can fit into a specific well. This information may include the volume of the pill and the shape of the pill. The medication pack design module 108 can also retrieve the dimensions of the medication well. The volumes of the medications can be summed. If the collective volumes of the medications are less than a percentage of the volume of the medication well, then the medications are determined to fit in the medication well. Otherwise, the medication pack design module 108 may select a larger medication well for the particular time slot.

Other means for determining if a group of medications will fit into a medication well are also contemplated. For instance, the medication pack design module 108 may store combinations of medications that are known to fit into a particular sized medication well. When a new combination is called for using smaller medications than a previous combination that fit into an equally sized medication well, then medication pack design module 108 infers that the new combination would fit into the medication well.

The medication pack design module 108 will assign each dose of medication at a time slot to its corresponding well. This can be achieved by storing information for the medication pack and for each medication well in the medication pack, as shown at step 708. In this step, the medication pack design module 108 can generate and store information relating to each well and the contents to be packaged therein. It is contemplated that the information can be stored in an electronically readable format such as XML.

The medication pack design module 108 also defines the content to be printed on the medication pack. As described with respect to FIGS. 3A and 3B, the medication pack may have printed material printed thereon, such as patient information, the time period of the medication pack, the contents of the medication pack, instructions for the patient, etc. The medication pack design module 108 generates all of the information to be included on the front and/or back of the medication pack. The printed content can be determined from a variety of sources. The patient information and the instructions for the patient can be retrieved from the patient information in the electronic medical records database 104. The time period for the medication can be determined from a clock on the device hosting the regimen CAD system 100. The time slots can be determined from the schedule. The medication pack design module 108 can format where the printed content will be located using predetermined templates, which have fields for the various types of printed content. The medication pack design module 108 can generate this content in any type of format. For instance, the printed content may be generated in a postscript language.

Once the medication pack layout and the printed content are set and the doses of medication are mapped to the medication wells, the medication pack design module 108 can either store the medication pack design and related data or can transmit the design and the related data to a destination. The destination may be a packaging device that receives a medication pack design and prepares a customized medication pack according to the medication pack design. In some embodiments, the medication pack design module 108 may transmit the medication pack design and the related data to a pharmacy or an equivalent thereof, where the medication pack is prepared by a pharmacist or the like.

It is noted that although medication packs having n×m medication wells have been described, where n is the number of rows and m is the number of columns in the medication pack, the medication pack can have any configuration of medication wells. FIG. 3C depicts an example of a medication pack 380 that has a non uniform configuration. As can be seen, row 382 has four wells, while row 384 has 3 wells. Furthermore, while the medication packs shown in the figures are blister packs, other types of medication packs are also contemplated. For example, medication packs containing bags or cells can be used to package the doses of medication. Furthermore, the disclosure is not limited to doses of medication in pill form, but also in liquid or powder form as well. If a liquid is used, the medication pack may include a vial for one or more doses of medication in liquid form.

The method for designing a medication pack is an exemplary method and it is contemplated that other methods can be performed to design a medication pack. Furthermore, the ordering of the steps described above is not essential and other steps may be performed as well. Additionally, if the medication pack is one that is used with a medication dispensing device, the schedule may also be communicated to the medication dispensing device.

In some embodiments, the medication pack layout, along with the prescription schedule and applicable patient information, is communicated to a medication packaging device. The medication packaging device is a device that can package doses of medication into a medication pack and print the printed content thereon. Suitable medication packaging devices are commercially available from Sanyo Electric Co. (e.g., Sanyo Automatic Tablet Counting and Packaging Machines ATC-320G and ATC-256G). Such medication packaging device can be configured in accordance with the principles of this disclosure. For example, the medication packaging device may be configured to receive a medication pack layout, the mappings of the doses of medication to the medication wells, the printed content, and patient related data. Further, the packaging device may also receive the actual medication and packaging materials. Based on the medication pack layout, the mappings of the doses of medication to the medication wells, the printed content, and patient related data, the medication packaging device can be configured to insert each of the doses of medication in its corresponding well, seals the medication pack, and prints the printed content on the medication pack. Furthermore, the medication packaging device may be further configured to print instructions for administering the medications, to print shipping labels for shipping the medication to the patient, and to perform other logistical tasks.

In other embodiments, the medication pack layout is communicated to a pharmacy or a drug manufacturer. In these embodiments, a user or device can package the various medications in the medication pack, which is then provided to the patient.

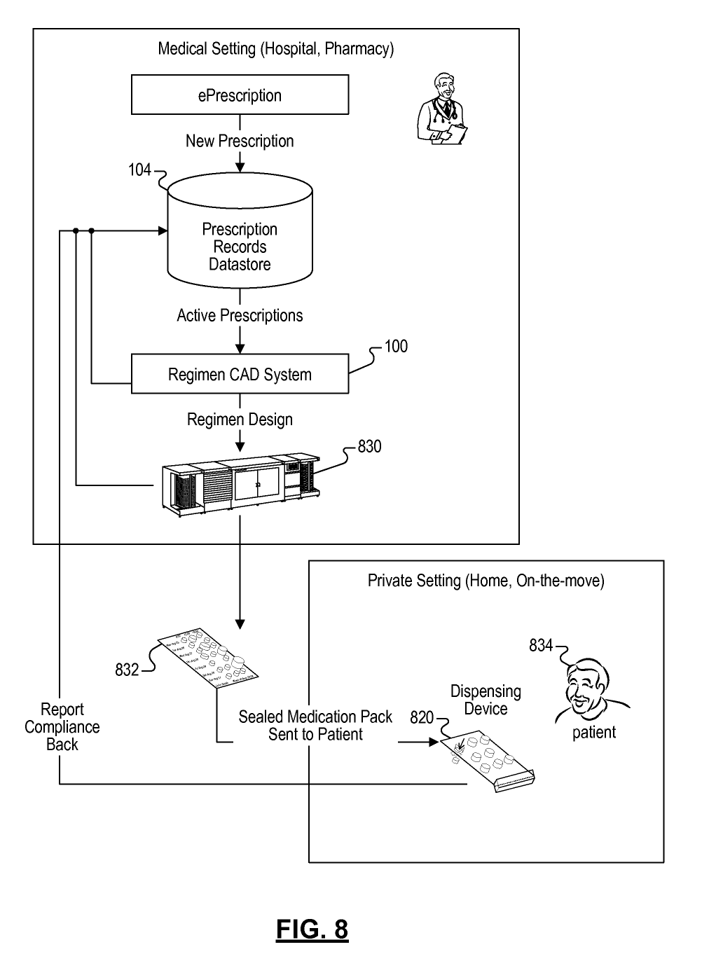

FIG. 8 is a diagram illustrating an exemplary deployment of the automated medication supply chain system. Of note, the computer aided regimen design (“regimen CAD”) system 100, the electronic medical records database 104 and the medication packaging robot 830 are located in a secure/trusted environment, such as a pharmacy, hospital or another type of secure medical facility that is approved for handling personal information prescriptions and medications potentially allowing traceability and audits. Once manufactured, the medication pack 832 is a self sufficient entity containing both the physical medication and their related descriptions within the same sealed package that can be delivered to the patient 834 for use. This medication package 832 might be securely dispensed by a dispenser device 820 guiding the user towards compliance. The dispensing device 820 might record defective dispensing times and report them back to the electronic medical records, therefore closing the loop with trusted records. Further, the dispensing device 820 can report any other statistics relating to the patient's administration of the medication, such as compliance, shifts in administration times, or the like.

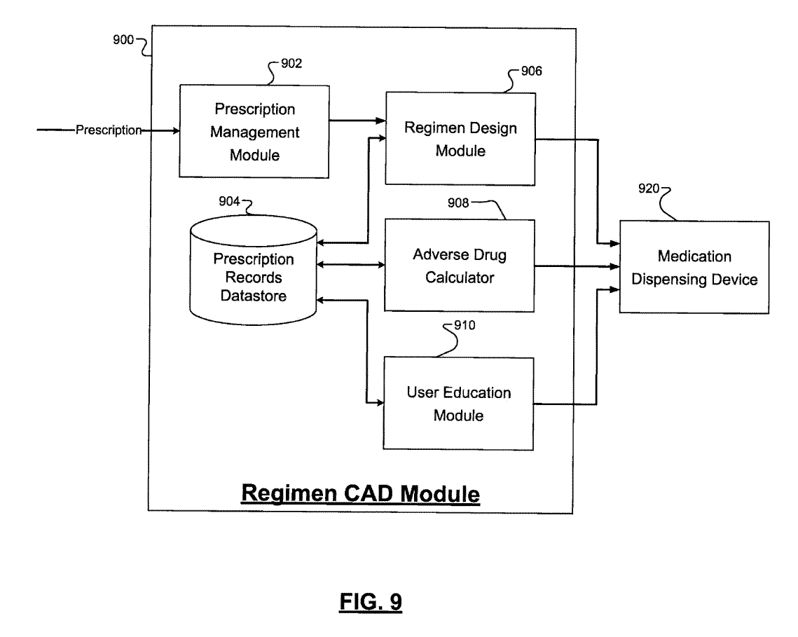

Referring now to FIG. 9, in some embodiments, the regimen CAD system 900 does not design a medication pack layout. Rather, the schedule for administering doses of medication to a patient is generated by the regimen CAD system 900 and can be communicated to a medication dispensing device 820, which dispenses doses of medication to the patient in adherence to the schedule. A medication dispensing device can be any device that delivers a dose of medication to patient or notifies a patient when a dose of medication should be taken. For example, U.S. Patent Publication No. 2009/0259486 discloses different examples of medication dispensing devices. Some medication dispensing devices can be configured to report back to a physician if a patient is taking the medication in accordance with the prescription. This devices can be configured to report the same to the prescription record database 904 so that records relating to the patients adherence to the schedule.

It is noted that the functionality of the regimen CAD system 100 900 is consistent with the functionality of the regimen CAD system 100 described above, except that the schedule for administering the doses of medication is not used to generate a medication pack layout. Furthermore, the exemplary regimen CAD system 900 may also include an adverse drug effect calculator 908 and a user education module 910.

The adverse drug calculator 908 analyzes combinations of medications taken by the patient. Further, the adverse drug calculator 908 also analyzes how doses of medication taken at a first time effect doses of medication taken at a second time. It is envisioned that any algorithm that calculates adverse drug effects can be implemented in the adverse drug effect calculator 908. The output of the adverse drug effect calculator is communicated to the medication dispensing device 820. It is envisioned that the regimen CAD system 100 of FIG. 1 may also include an adverse drug calculator. In those embodiments the information can be printed on paper and provided with the medication pack. Furthermore, the adverse drug calculator can be used to compute possible adverse drug effects when generating the schedule for administering the doses of medication.

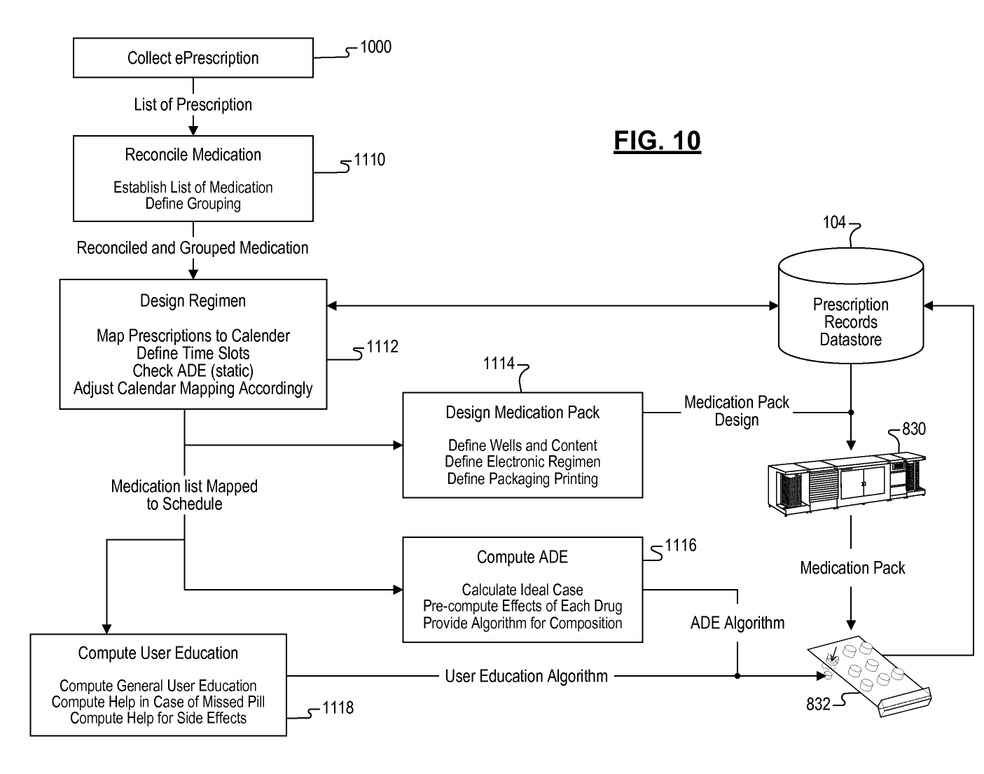

The user education module 910 retrieves information relating to medications administered to the patient for various sources, which may include the medical records database 904 or a database of the medication manufacturer. The information that is retrieved is information that provides instructions to the patient. For example, the information may include possible side effects of the medication, the composition of the medication, or instructions to follow if a scheduled dose is missed. The retrieved information can be communicated to the medication dispensing device 820. It is envisioned that the regimen CAD system 100 of FIG. 1 may also include a user education module. In those embodiments the information can be printed on paper and provided with the medication pack. It is further envisioned that this information may be printed content that is printed on the back of the medication pack. Integration of the adverse drug effect analysis and computer-based user education functions in the overall system is shown in FIG. 10.

It is noted that the regimen CAD systems described above may be implemented in a variety of systems. For example, a regimen CAD system 100 may be included in a medication management system of a hospital, health care provider, pharmacy or medication manufacturer. In some embodiments a regimen CAD system 100 can be integrated into a medication packaging device or a computer in communication with the medication packaging device. In other embodiments, a regimen CAD system 100 may be integrated on a medication dispensing device or a computer in communication with the medication dispensing device.

As used herein, the term module may refer to, be part of, or include an Application Specific Integrated Circuit (ASIC), an electronic circuit, a processor (shared, dedicated, or group) and/or memory (shared, dedicated, or group) that execute one or more software or firmware programs, a combinational logic circuit, and/or other suitable components that provide the described functionality. It should be understood that when describing a software or firmware program, the term module may refer to computer executable instructions residing on an computer readable medium and executable by a processor. It is further understood that the modules and components described in this disclosure may be further broken down into sub modules and subcomponents. Further the methods described herein may be computer implemented methods such that they are executable on a processor.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

What is claimed is:

1. A method for generating a medication regimen for a patient, comprising:
receiving two or more prescriptions for the patient, where each prescription indicates a medication prescribed to the patient and a frequency for administering doses of the medication to the patient;
determining at least one constraint regarding administering the medications to the patient; and
mapping each dose of medication to calendar slots of a calendar using a constraint propagation algorithm, where the constraint propagation algorithm recursively maps the doses of the prescribed medication to the calendar in accordance with the constraint and the prescribed frequency for administering the medication, and reschedules a previously scheduled dose of medication when a given dose of the medication cannot be mapped to the calendar in accordance with the constraint and the prescribed frequency for administering the medication.

2. The method of claim 1 further comprises defining a constraint that dictates a time at which to administer a given medication.

3. The method of claim 1 further comprises defining each calendar slot as a time of day at which to administer the dose of medication, thereby defining a prescription schedule for the patient.

4. The method of claim 3 further comprising mapping the number of calendar slots on the calendar during a given period of time to a pre-defined number of time slots that is less the number of calendar slots.

5. The method of claim 1 further comprises
determining a set of constraints regarding administering the medication to the patient, each constraint dictates a time at which to administer a given medication and has a priority in relation to the other constraints in the set of constraints;
associating each of the constraints in the set of constraints with an applicable medication prescribed to the patient;
identifying medication associated with the constraint having the highest priority in the set of constraints; and
mapping doses of the identified medication to a calendar in accordance with the associated constraint.

6. The method of claim 5 further comprises
identifying medication associated with the constraint having the next highest priority in the set of constraints;
mapping doses of the identified medication with the constraint having the next highest priority to the calendar in accordance with the associated constraint; and
repeating the steps of identifying medication and mapping the identified medication for each of the remaining constraints in the set of constraints.

7. The method of claim 5 further comprises receiving a policy for administering the medication to the patient and retrieving the set of constraints based on the received policy.

8. The method of claim 3 further comprises generating a layout for a medication pack for the patient based on the prescription schedule, where the medication pack includes a plurality of containers for housing medication and each container corresponds to a time slot of the prescription schedule.

9. The method of claim 8 further comprises
transmitting the layout for the medication pack via a communication link to a medication packaging machine;
manufacturing a medication pack for the patient, the medication pack manufactured by the medication packaging machine in accordance with the layout for the medication pack; and
delivering the medication pack to the patient.

10. The method of claim 1 wherein the constraint propagation algorithm recursively performs steps comprising:
i) attempting to map a dose of a medication being scheduled to a proposed calendar slot of the calendar in accordance with a constraint corresponding to the medication of the dose being scheduled and a constraint of a previously scheduled dose of medication,
ii) attempting to map the dose of medication being scheduled to a next calendar slot of the calendar when at least one of the constraints of the medication being scheduled and the constraint of the previously scheduled dose of medication preclude scheduling the dose of medication being mapped to the proposed calendar slot; and
iii) remapping the previously scheduled dose of medication to a different calendar slot of the calendar when the dose of medication being scheduled cannot be mapped to any calendar slots of the calendar because of at least one of the constraint of the medication being scheduled and the constraint of the previously scheduled dose of medication.

11. A method for generating a medication regimen for a patient, comprising:
receiving two or more prescriptions for the patient, where each prescription indicates a medication prescribed to the patient and a frequency for administering doses of the medication to the patient;
receiving a set of constraints regarding administering the medication to the patient, each constraint having a priority in relation to the other constraints in the set of constraints;
associating each of the constraints in the set of constraints with an applicable medication prescribed to the patient;
identifying medication associated with the constraint having the highest priority in the set of constraints; and
mapping doses of the identified medication to a calendar using a constraint propagation algorithm in accordance with the associated constraint and the prescribed frequency for administering the identified medication.

12. The method of claim 11 further comprises
identifying medication associated with the constraint having the next highest priority in the set of constraints;
mapping doses of the identified medication with the constraint having the next highest priority to the calendar using the constraint propagation algorithm in accordance with the associated constraint and the prescribed frequency for administering the identified medication; and
repeating the steps of identifying medication and mapping the identified medication for each of the remaining constraints in the set of constraints.

13. The method of claim 11 wherein constraints in the set of constraints dictates a time at which to administer a given medication.

14. The method of claim 11 further comprises mapping doses of the identified medication to a time slot of the calendar, where the time slot indicates a time of day at which to administer the dose of medication, thereby defining a prescription schedule for the patient.

15. The method of claim 11 further comprises receiving a first policy for administering the medication to the patient and retrieving the set of constraints that correlates to the first policy.

16. The method of claim 15 further comprises receiving a second policy for administering the medication that differs from the first policy, retrieving another set of constraints that correlates to the second policy, and applying another set of constraints when generating the medication regimen for the patient, where the constraints or priorities amongst the constraints in the another set of constraints differs from the set of the constraints.

17. The method of claim 11 further comprises mapping the doses of the identified medication using a backtracking algorithm.

18. The method of claim 14 further comprises generating a layout for a medication pack for the patient based on the prescription schedule, where the medication pack includes a plurality of containers for housing medication and each container corresponds to a time slot of the prescription schedule.

19. The method of claim 18 further comprises
transmitting the layout for the medication pack via a communication link to a medication packaging machine;
manufacturing a medication pack for the patient, the medication pack manufactured by the medication packaging machine in accordance with the layout for the medication pack; and
delivering the medication pack to the patient.

20. A method for designing a layout for a medication pack for a patient, comprising:
receiving a plurality of prescriptions for the patient, wherein a prescription of the plurality of prescriptions indicates a medication prescribed to the patient and a frequency for administering a dose of the medication;
determining a schedule for administering the medication prescribed to the patient from the plurality of prescriptions, the schedule specifying time slots at which to administer a dose of medication and the medication to be taken during the time slot; and
generating a layout for a medication pack for the patient based on the schedule, where the medication pack includes a plurality of containers for housing medication and each container corresponds to a time slot of the schedule.

21. The method of claims 20 wherein generating a layout for a medication pack further comprises arranging the plurality of containers in one or more rows, where each row representing same duration of time on the schedule.

22. The method of claims 21 further comprises arranging one or more containers in each row of containers, where each container in a given row corresponds to a time slot on the schedule occurring during the time duration.

23. The method of claim 20 wherein generating a layout for a medication pack further comprises arranging the plurality of containers as an array of rows and columns, where each row represents a day of a week and each column represents a time of day for administering the medication.

24. The method of claim 20 further comprising selecting an amount of medication wells in the medication pack based on an amount of time slots in the schedule.

25. The method of claim 21 further comprises defining content to be printed on the medication pack.

26. The method of claim 25 wherein the printed content includes an indicia of a time at which to administer the medication.

27. The method of claim 21 further comprises
providing the layout for the medication pack to a pharmacist, wherein the pharmacist prepares a medication pack in accordance with the layout for the medication pack; and
delivering the medication pack to the patient.

28. The method of claim 21 further comprises
transmitting the layout for the medication pack via a communication link to a medication packaging machine;
manufacturing a medication pack for the patient, the medication pack manufactured by the medication packaging machine in accordance with the layout for the medication pack; and
delivering the medication pack to the patient.

29. The method of claim 21 wherein determining a schedule further comprises mapping each dose of medication to calendar slots of a calendar using a constraint propagation algorithm, where the constraint propagation algorithm recursively maps the doses of the prescribed medication to the calendar in accordance with prescribed frequency for administering the medication, and reschedules a previously scheduled dose of medication when a given dose of the medication cannot be mapped to the calendar in accordance with the prescribed frequency for administering the medication

30. An apparatus for generating a medication regimen for a patient, comprising:
a prescription management module that is configured to receive two or more prescriptions for the patient, where each prescription indicates a medication prescribed to the patient and a frequency for administering doses of the medication to the patient; and
a regimen design module that is configured to determine at least one constraint regarding administering the medications to the patient and to map each dose of medication to calendar slots of a calendar using a constraint propagation algorithm, where the constraint propagation algorithm recursively maps the doses of the prescribed medication to the calendar in accordance with the constraint and the prescribed frequency for administering the medication, and reschedules a previously scheduled dose of medication when a given dose of the medication cannot be mapped to the calendar in accordance with the constraint and the prescribed frequency for administering the medication.

31. The apparatus of 30 wherein the constraint dictates a time at which to administer a given medication.

32. The apparatus of 30 wherein the regimen design module defines each calendar slot as a time of day at which to administer the dose of medication, thereby defining a prescription schedule for the patient.

33. The apparatus of 30 wherein the regimen design model maps the number of calendar slots on the calendar during a given period to time to a pre-defined number of time slots that is less the number of calendar slots.

34. The apparatus of 30 wherein the regimen design model determines a set of constraints regarding administering the medication to the patient, each constraint dictates a time at which to administer a given medication and has a priority in relation to the other constraints in the set of constraints; associates each of the constraints in the set of constraints with an applicable medication prescribed to the patient; identifies medication associated with the constraint having the highest priority in the set of constraints; and maps doses of the identified medication to a calendar in accordance with the associated constraint.

35. The apparatus of 34 wherein the regimen design model receives a policy for administering the medication to the patient and retrieves the set of constraints based on the received policy.

36. The apparatus of claim 32 wherein the regimen design model transmits the prescription schedule via a communication link to a medication packaging machine.

37. The apparatus of 32 further comprises a medication pack design module that generates a layout for a medication pack for the patient based on the prescription schedule received from the regimen design module, where the medication pack includes a plurality of containers for housing medication and each container corresponds to a time slot of the prescription schedule.

38. The apparatus of 37 wherein the medication pack design module arranges the plurality of containers in one or more rows, where each row representing same duration of time on the schedule.

39. The apparatus of claim 38 wherein the medication pack design module arranges one or more containers in each row of containers, where each container in a given row corresponds to a time slot on the schedule occurring during the time duration.

40. The apparatus of 37 wherein the medication pack design module arranges the plurality of containers as an array of rows and columns, where each row represents a day of a week and each column represents a time of day for administering the medication

41. The apparatus of 37 wherein the medication pack design module transmits the layout for the medication pack via a communication link to a medication packaging machine.

42. A method for manufacturing a medication pack for a patient comprising:
receiving a medication pack layout indicating an arrangement of medication containers in the medication pack and mappings of a plurality of doses of different medications to individual medication containers, wherein the mappings correspond to a schedule for administering the plurality of doses to the patient;
inserting each mapped dose of medication of the plurality of doses of different medications in a corresponding medication container, wherein each medication container having a dose of medication mapped thereto has at least one dose of medication inserted therein; and
delivering the medication pack to the patient.

43. The method of claim 42 further comprising receiving printed content indicating time slots corresponding to the schedule for administering the plurality of doses and printing the printed content on the medication such that the printed content indicating the time slots corresponds to the mappings of the doses of different medications to the medication containers.

44. The method of claim 42 further comprising receiving printed content indicating patient information and printing the patient information on the medication pack.

45. The method of claim 42 wherein at least the inserting step is performed by a medication packaging device.

46. The method of claim 42 further comprising receiving the schedule for administering the plurality of doses of medication and determining the medication pack layout based on the schedule.

47. The method of claim 46 further comprising determining an amount of scheduled doses in a given time period and determining the arrangement of medication containers in the medication pack based on the amount of scheduled doses in the given time period.
